(19) United States
(12) Patent Application Publication
(10) Pub. No.: US 2006/0076325 A1
(43) Pub. Date: Apr. 13, 2006

(54) Heating device having electrothermal film

(76) Inventor: Cheng-Ping Lin, Taipei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/963,452

(22) Filed: Oct. 13, 2004

(51) Int. Cl. B23K 9/00; B23K 9/02

(52) U.S. Cl. 219/121.45

(57) ABSTRACT

A heating device includes a substrate added with a functional far infrared material, an electrothermal film layer coated on a surface of the substrate, and two electrodes mounted on two opposite sides of the electrothermal film layer and each electrically connected to the electrothermal film layer. Thus, the electrothermal film layer co-operates with the functional far infrared material contained in the substrate to produce heat by conduction of the two electrodes so as to heat an object to be heated, thereby simplifying the construction of the heating device, and thereby enhancing the heating efficiency of the heating device.

### BACKGROUND OF THE INVENTION

1. Field of the Invention

The present invention relates to a heating device, and more particularly to a heating device having an electrothermal film to function as a heat source.

2. Description of the Related Art

A conventional heating device includes a heating element consisting of a nickel-chromium coil or a quartz tube disposed at a proper position. The heating element is heated in a heat convection manner with the air as a medium of heat transfer. However, the heat transfer efficiency in the air is poor, so that the heating temperature of the heating element is not evenly distributed. In addition, the conventional heating device has a larger volume, and the heating temperature of the heating element cannot be controlled easily.

Another conventional heating device is disclosed in the Taiwanese Patent Publication No. 472997 and comprises an electrothermal film. The electrothermal film includes a substrate, a silver gel, and an electrode. The substrate has a first side provided with a far infrared layer and a second side provided with an electrothermal film layer. The electrothermal film layer has a conductive protective layer having an oxidation surface. The silver gel is located at a predetermined position of the protective layer and is electrically connected to an inside of the protective layer. The electrode is electrically connected to the electrothermal film layer through the protective layer and the silver gel. Thus, the electrothermal film layer co-operates with the far infrared layer to produce far infrared rays so as to heat a target efficiently. In such a manner, the conventional heating device uses the electrothermal film to function as a heating source.

However, the substrate is provided with the far infrared layer in a high temperature sintering manner, thereby complicating the working process. In addition, the substrate is located between the far infrared layer and the electrothermal film layer, thereby decreasing the heat transfer efficiency. Further, the electrothermal film is made of electric resistance material, so that the temperature cannot be controlled easily. Thus, it is necessary to provide a temperature control device additionally.

### SUMMARY OF THE INVENTION

In accordance with the present invention, there is provided a heating device, comprising:

a substrate added with a functional far infrared material;

an electrothermal film layer coated on a surface of the substrate; and

two electrodes mounted on two opposite sides of the electrothermal film layer and each electrically connected to the electrothermal film layer.

The primary objective of the present invention is to provide a heating device having an electrothermal film to function as a heat source.

Another objective of the present invention is to provide a heating device, wherein the substrate is integrally formed with the functional far infrared material without needing a high temperature sintering process, thereby simplifying the manufacturing process, and thereby simplifying the construction of the heating device.

A further objective of the present invention is to provide a heating device, wherein the functional far infrared material has a function of converting the far infrared rays, thereby enhancing the heating efficiency of the heating device.

A further objective of the present invention is to provide a heating device, wherein the thermal insulating layer is coated on the top face of the electrothermal film layer to provide a thermal insulating effect to the electrothermal film layer.

Further benefits and advantages of the present invention will become apparent after a careful reading of the detailed description with appropriate reference to the accompanying drawings.

### BRIEF DESCRIPTION OF THE DRAWINGS

FIG. 1 is a plan view of a heating device in accordance with the preferred embodiment of the present invention; and

FIG. 2 is a plan cross-sectional view of the heating device in accordance with the preferred embodiment of the present invention.

### DETAILED DESCRIPTION OF THE INVENTION

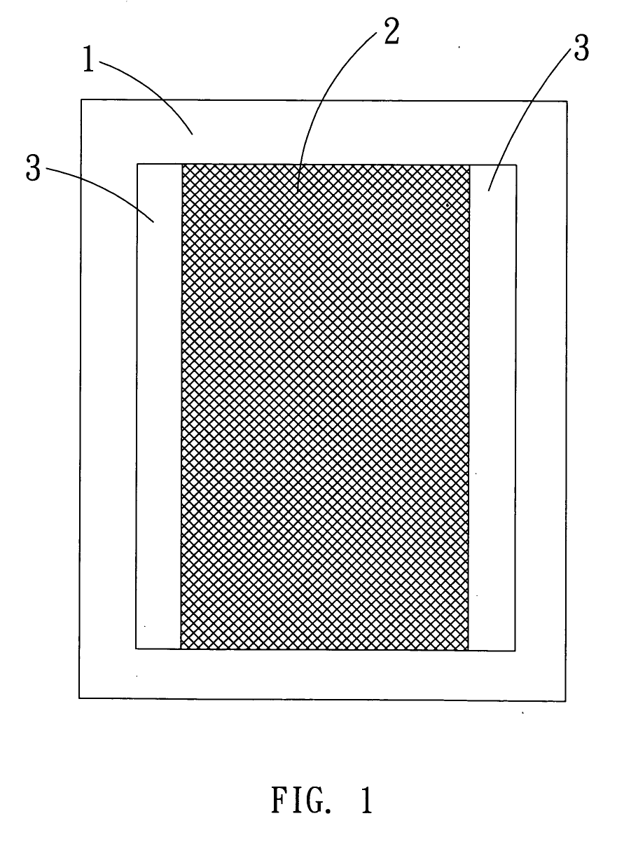

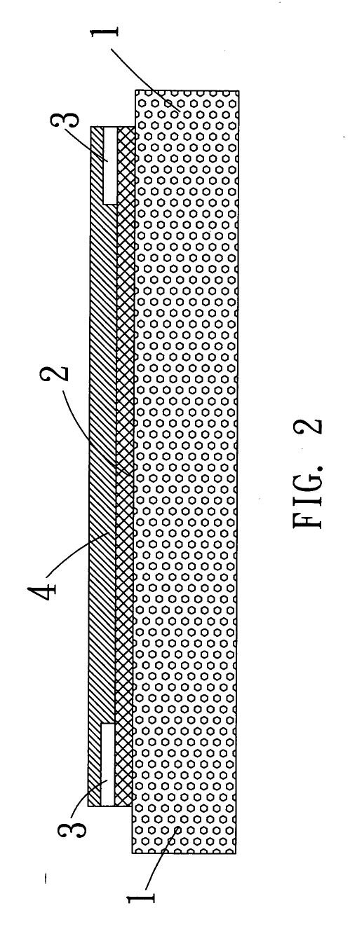

Referring to FIGS. 1 and 2, a heating device in accordance with the preferred embodiment of the present invention comprises a substrate 1 added with a functional far infrared material, an electrothermal film layer 2 coated on a surface of the substrate 1, two electrodes 31 mounted on two opposite sides of the electrothermal film layer 2 and each electrically connected to the electrothermal film layer 2, and a thermal insulating layer 4 coated on a top face of the electrothermal film layer 2 to provide a thermal insulating effect to the electrothermal film layer 2.

Thus, the electrothermal film layer 2 co-operates with the functional far infrared material contained in the substrate 1 to produce heat by conduction of the two electrodes 31 so as to heat an object to be heated evenly.

Preferably, the functional far infrared material is made a ceramic material. Preferably, the functional far infrared material is mixed with the substrate 1 before the substrate 1 is formed, so that the substrate 1 is integrally formed with the functional far infrared material without needing a high temperature sintering process, thereby simplifying the manufacturing process.

The electrothermal film layer 2 is made of tin, nickel and chromium alloy, copper and nickel alloy or the like. In addition, the electrothermal film layer 2 is coated on the substrate 1 by a thermal chemical reaction method, such as a high temperature atomized growth method.

Accordingly, the substrate 1 is integrally formed with the functional far infrared material without needing a high temperature sintering process, thereby simplifying the manufacturing process, and thereby simplifying the construction of the heating device. In addition, the functional far infrared material has a function of converting the far infrared rays, thereby enhancing the heating efficiency of the heating device. Further, the thermal insulating layer 4 is coated on the top face of the electrothermal film layer 2 to provide a thermal insulating effect to the electrothermal film layer 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A heating device, comprising:
a substrate added with a functional far infrared material;
an electrothermal film layer coated on a surface of the substrate; and
two electrodes mounted on two opposite sides of the electrothermal film layer and each electrically connected to the electrothermal film layer.

2. The heating device in accordance with claim 1, further comprising a thermal insulating layer coated on a top face of the electrothermal film layer to provide a thermal insulating effect to the electrothermal film layer.

3. The heating device in accordance with claim 1, wherein the electrothermal film layer co-operates with the functional far infrared material contained in the substrate to produce heat by conduction of the two electrodes so as to heat an object to be heated evenly.

4. The heating device in accordance with claim 1, wherein the substrate is integrally formed with the functional far infrared material.

5. The heating device in accordance with claim 1, wherein the functional far infrared material is mixed with the substrate before the substrate is formed.

6. The heating device in accordance with claim 1, wherein the electrothermal film functions as a heat source.
